(19) United States
(12) Patent Application Publication
(10) Pub. No.: US 2006/0010694 A1
(43) Pub. Date: Jan. 19, 2006

(54) Knife assembly having quick release blade magazine

(76) Inventors: Yi Ying Chen, Taichung County (TW); Guei Ying Wang, Taichung City (TW)

Correspondence Address: CHARLES E. BAXLEY, ESQ., 90 JOHN STREET, THIRD FLOOR, NEW YORK, NY, 10038, US

(21) Appl. No.: 10/892,636

(22) Filed: Jul. 16, 2004

(51) Int. Cl. B26B 3/06; F41B 13/02

(52) U.S. Cl. 30/162

(57) ABSTRACT

A knife assembly includes a handle, a blade magazine detachably mounted in the handle, and a plurality of blades mounted in the blade magazine. Thus, the blade magazine is released from the handle easily and rapidly, thereby facilitating a user replacing the blades contained in the blade magazine. In addition, the blade magazine is mounted to the handle easily and conveniently, thereby facilitating the user mounting the blade magazine. Further, the blade magazine contains a plurality of blades, thereby facilitating the user carrying the blades.

### BACKGROUND OF THE INVENTION

1. Field of the Invention

The present invention relates to a stationery knife assembly, and more particularly to a knife assembly having a quick release blade magazine.

2. Description of the Related Art

A conventional stationery knife comprises a handle, a blade movably mounted in the handle, and a push member movably mounted on the handle and secured on the blade to push the blade so as to push the blade outward from the handle or to retract the blade into the handle. However, the blade cannot be detached from the handle easily and conveniently, thereby causing inconvenience to a user in replacement of the blade. In addition, the handle contains a single blade therein, thereby decreasing the versatility of the conventional stationery knife.

### SUMMARY OF THE INVENTION

The present invention is to mitigate and/or obviate the disadvantage of the conventional stationery knife.

The primary objective of the present invention is to provide a knife assembly having a quick release blade magazine.

Another objective of the present invention is to provide a knife assembly, wherein the blade magazine is released from the handle easily and rapidly, thereby facilitating a user replacing the blades contained in the blade magazine.

A further objective of the present invention is to provide a knife assembly, wherein the blade magazine is mounted to the handle easily and conveniently, thereby facilitating the user mounting the blade magazine.

A further objective of the present invention is to provide a knife assembly, wherein the blade magazine contains a plurality of blades, thereby facilitating the user carrying the blades.

In accordance with the present invention, there is provided a knife assembly, comprising a handle, a blade magazine detachably mounted in the handle, and a plurality of blades mounted in the blade magazine, wherein:

the handle has an inside formed with a slideway and a catch block and has an end portion having a peripheral wall formed with a through hole communicating with the slideway;

the end portion of the handle is provided with a press block movably mounted in the through hole and having a distal end formed with an urging stud; and

the blade magazine is slidably mounted in the slideway of the handle and has a side formed with a positioning plate having a distal end formed with a locking block detachably locked on the catch block of the handle and rested on the urging stud of the press block.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a knife assembly in accordance with the preferred embodiment of the present invention;

FIG. 2 is an exploded perspective view of the knife assembly as shown in FIG. 1;

FIG. 3 is a plan cross-sectional view of the knife assembly as shown in FIG. 1;

FIG. 4 is a partially enlarged view of the knife assembly as shown in FIG. 3;

FIG. 5 is a schematic operational view of the knife assembly as shown in FIG. 3;

FIG. 6 is a schematic operational view of the knife assembly as shown in FIG. 5; and

FIG. 7 is a schematic operational view of the knife assembly as shown in FIG. 6.

### DETAILED DESCRIPTION OF THE INVENTION

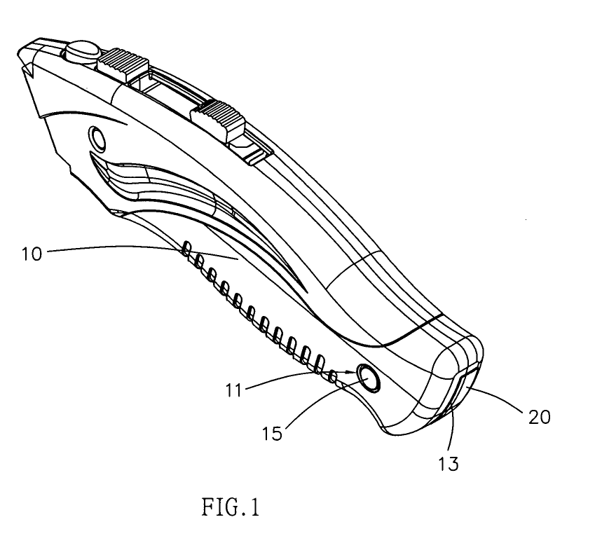

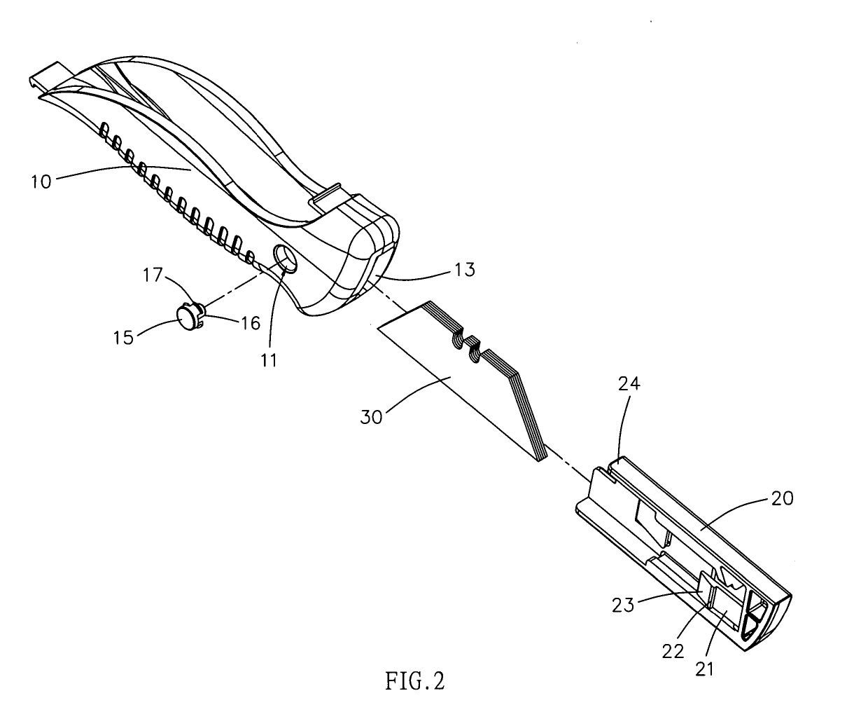

Referring to the drawings and initially to FIGS. 1-4, a knife assembly in accordance with the preferred embodiment of the present invention comprises a handle 10, a blade magazine 20 detachably mounted in the handle 10, and a plurality of blades 30 mounted in the blade magazine 20.

The handle 10 is a hollow body and has an inside formed with a slideway 13. The handle 10 has an end portion having a peripheral wall formed with a through hole 11 communicating with the slideway 13. The inside of the handle 10 is formed with a catch block 12 located adjacent to the through hole 11. The end portion of the handle 10 is provided with an elastic press block 15 movably mounted in the through hole 11 and having a distal end formed with an urging stud 16. Preferably, the press block 15 is located adjacent to the catch block 12. The press block 15 has a periphery formed with a hook-shaped snapping plate 17 snapped onto an end face of the through hole 11 for retaining the press block 15 in the through hole 11 of the handle 10. A compression spring 25 is mounted in the inside of the handle 10 and located in an end of the slideway 13 of the handle 10.

The blade magazine 20 is slidably mounted in the slideway 13 of the handle 10 and has a side formed with an elastic positioning plate 21 having a distal end formed with a locking block 22 detachably locked on the catch block 12 of the handle 10 and rested on the urging stud 16 of the press block 15. Preferably, the locking block 22 of the positioning plate 21 of the blade magazine 20 is substantially wedge shaped and has a side formed with an oblique guide face 23 rested on the urging stud 16 of the press block 15 to facilitate insertion of the blade magazine 20 into the inside of the handle 10. The blade magazine 20 has an end formed with an urging plate 24 rested on the compression spring 25, so that the compression spring 25 is biased between the handle 10 and the urging plate 24 to force the blade magazine 20 to move outward relative to the handle 10.

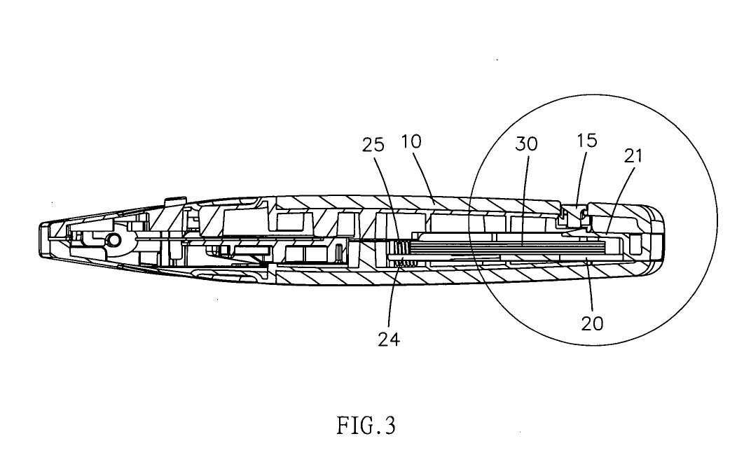

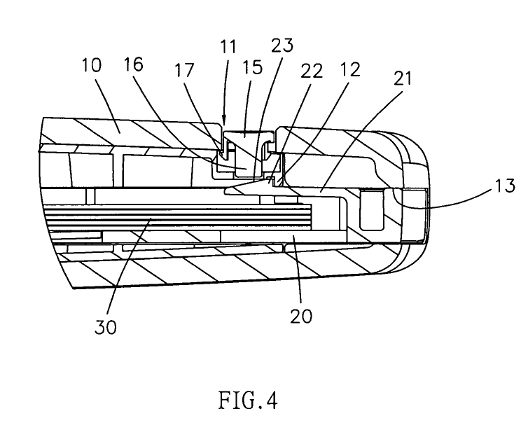

In operation, referring to FIGS. 1-7, the locking block 22 of the blade magazine 20 is locked on the catch block 12 of the handle 10 as shown in FIGS. 3 and 4, so that the blade magazine 20 is fixed in the slideway 13 of the handle 10 without movement. At this time, the urging stud 16 of the press block 15 is rested on the guide face 23 of the locking block 22 of the blade magazine 20.

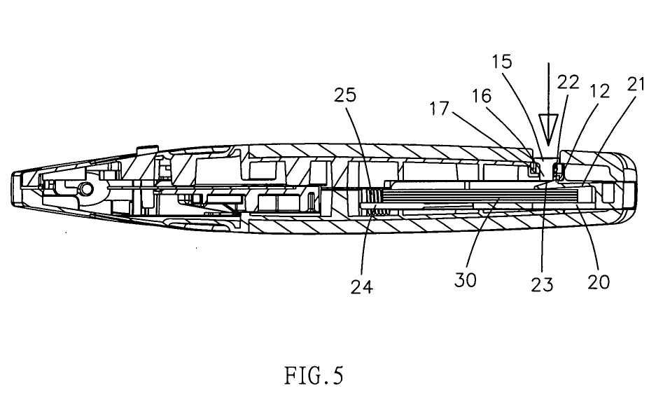

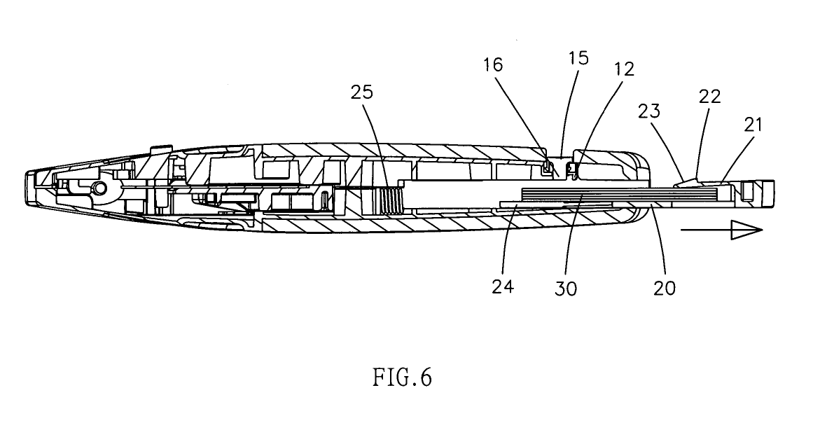

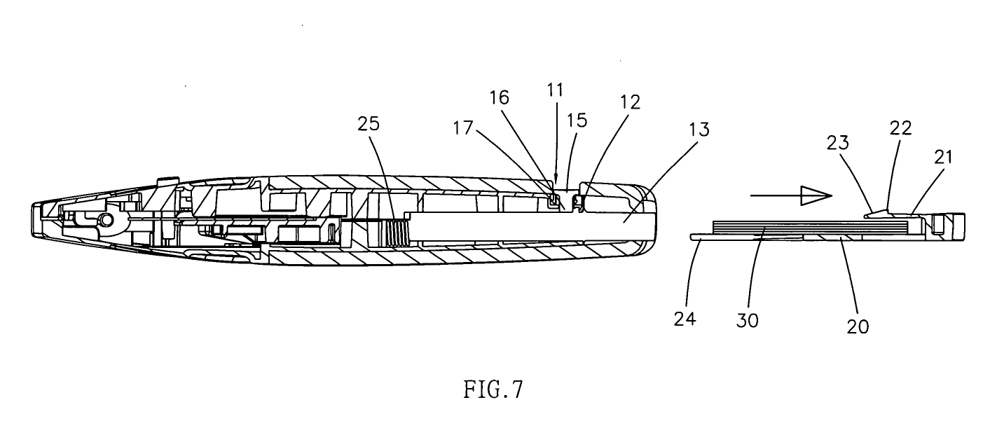

As shown in FIG. 5, when the press block 15 is pressed toward the locking block 22 of the blade magazine 20, the urging stud 16 of the press block 15 is urged on the guide face 23 of the locking block 22 of the blade magazine 20 to move and detach the locking block 22 of the blade magazine 20 from the catch block 12 of the handle 10, so that the blade magazine 20 is forced to move outward relative to the handle 10 by the restoring force of the compression spring 25 as shown in FIG. 6, thereby quickly detaching the blade magazine 20 from the handle 10 as shown in FIG. 7.

Accordingly, the blade magazine 20 is released from the handle 10 easily and rapidly, thereby facilitating a user replacing the blades 30 contained in the blade magazine 20. In addition, the blade magazine 20 is mounted to the handle 10 easily and conveniently, thereby facilitating the user mounting the blade magazine 20. Further, the blade magazine 20 contains a plurality of blades 30, thereby facilitating the user carrying the blades 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A knife assembly, comprising a handle, a blade magazine detachably mounted in the handle, and a plurality of blades mounted in the blade magazine, wherein:
the handle has an inside formed with a slideway and a catch block and has an end portion having a peripheral wall formed with a through hole communicating with the slideway;
the end portion of the handle is provided with a press block movably mounted in the through hole and having a distal end formed with an urging stud; and
the blade magazine is slidably mounted in the slideway of the handle and has a side formed with a positioning plate having a distal end formed with a locking block detachably locked on the catch block of the handle and rested on the urging stud of the press block.

2. The knife assembly in accordance with claim 1, wherein the handle is a hollow body.

3. The knife assembly in accordance with claim 1, wherein the catch block of the handle is located adjacent to the through hole.

4. The knife assembly in accordance with claim 1, wherein the press block is elastic.

5. The knife assembly in accordance with claim 1, wherein the press block is located adjacent to the catch block.

6. The knife assembly in accordance with claim 1, wherein the press block has a periphery formed with a snapping plate snapped onto an end face of the through hole for retaining the press block in the through hole of the handle.

7. The knife assembly in accordance with claim 6, wherein the snapping plate is hook-shaped.

8. The knife assembly in accordance with claim 1, wherein the positioning plate of the blade magazine is elastic.

9. The knife assembly in accordance with claim 1, wherein the locking block of the positioning plate of the blade magazine is substantially wedge shaped.

10. The knife assembly in accordance with claim 1, wherein the locking block of the blade magazine has a side formed with a guide face rested on the urging stud of the press block.

11. The knife assembly in accordance with claim 10, wherein the guide face of the locking block of the blade magazine has an oblique shape.

12. The knife assembly in accordance with claim 1, further comprising a compression spring mounted in the inside of the handle and biased between the handle and the blade magazine.

13. The knife assembly in accordance with claim 12, wherein the blade magazine has an end formed with an urging plate rested on the compression spring.

14. The knife assembly in accordance with claim 12, wherein the compression spring is located in an end of the slideway of the handle.
